(19) United States
(12) Patent Application Publication
(10) Pub. No.: US 2025/0034908 A1
(43) Pub. Date: Jan. 30, 2025

(54) EXIT DEVICE DOOR LOCK AND EXIT DEVICE COMPRISING SAME

(71) Applicant: Seung Won LEE, Goyang-si, Gyeonggi-do (KR)

(72) Inventor: Seung Won LEE, Goyang-si, Gyeonggi-do (KR)

(21) Appl. No.: 18/707,156

(22) PCT Filed: Nov. 9, 2022
(86) PCT No.: PCT/KR2022/017504

§ 371 Date: May 2, 2024

(30) Foreign Application Priority Data
Nov. 17, 2021 (KR) 10-2021-0158959
Oct. 26, 2022 (KR) 10-2022-0138985

(51) Int. Cl. E05B 65/10; E05B 15/04; E05B 17/00

(52) U.S. Cl. CPC E05B 65/1053; E05B 15/04; E05B 17/0045

(57) ABSTRACT

The present invention relates to an exit device door lock and an exit device comprising same. To this end, the exit device of the present invention comprises: a device frame inserted into a door panel; a damper part inserted into the device frame and provided to absorb and damp impact power generated according to the operation of pushing parts; the pushing parts provided at both sides of the damper part to be pressable by a user; a slider provided to slidingly reciprocate along the device frame by the pushing part at the other side; and a slide bar coupled at one side thereof to the slider and provided such that the other side thereof is coupled to a door lock deadbolt by which a door is locked/unlocked.

### FIELD OF THE INVENTION

The present invention relates to an exit device door lock and an exit device comprising the same and, most particularly, to an exit device having all parts, except for a pushing part, embedded inside a door comprising a door lock having a deadbolt, so as to allow the door to have a simple appearance, which may enhance the effect of interior décor, and also having a newly configured operating structure of an opening and closing means, such as a push bar for entry and exit of the deadbolt, and an exit device door lock restricting arbitrary opening and closing of the deadbolt.

### BACKGROUND ART

Generally, a door lock device is a device allowing a latch, which is installed on one side of an entrance door, to enter a striker, which is installed to a doorframe. When the door is closed, the latch is inserted inside the striker due to its elasticity locking the door by restricting its rotation so that door does not open by itself. Afterwards, when a visitor turns a handle that is installed on the door, a rectangular lever spindle that is connected to the handle rotates the latch, thereby releasing the locked state is released. Then, the door is open by pushing the door forward.

Since the door lock device has a very simple entrance door opening and closing structure, usually, no problem occurs when using the door lock device. However, in urgent emergency situations where a large number of people is concentrated to the entrance at the same time, such as a fire or earthquake, since a user is required to turn the handle, this may not only cause a hindrance to a quick escape but may also lead to catastrophic accidents. For this, an exit device, which is an emergency escape device, is installed at entrances or emergency exits in buildings.

The exit device has a push bar installed on a mid-portion of the inner side of the door, which allows the door to open by simply pushing the push bar without using the hands. When the push bar is pushed, the locked state of the latch that is installed in the door is released by the pushing force of the push bar, thereby allowing the door to open by itself. Therefore, in emergency situations, people may be capable of escaping the disaster site more swiftly and easily as compared to when using the related art door lock device.

The exit device may be divided into a rim type, a mortise type, a vertical type, and so on. Herein, the mortise type is configured to have a structure where a mortise lock unit, which is embedded in one side of a door and rotates a latch, and a push bar unit, which is installed along a horizontal direction on an inner side of the door, are separated from one another.

A head assembly for a panic device of the Korean Patent Gazette No. 102028575 (Sep. 27, 2019) was proposed as the prior art. And, when configuring the head assembly for a panic device being applied to an evacuation exit or fire door (or fire protection door) of an emergency stairway, by simplifying a set of configurations that can implement the lock operating mechanism, and by adding a configuration that can prevent unauthorized release of a latch bolt, the proposed head assembly aimed to achieve a safer and smoother operation. However, as the push bar is constantly exposed on a front surface of the evacuation exit or fire door, there lies a problem in that the door may look coarse and unsophisticated and that noise may occur when operating the door.

Additionally, when a particular person positioned on an opposite side of the push bar relocates the deadbolt by applying pressure on the deadbolt of the door lock by using an arbitrary means, in a state where the push bar is not manipulated, the locked state may become arbitrarily released, causing the door to be unintentionally open. This may lead to problems of trespassing, theft, and so on.

### DETAILED DESCRIPTION OF THE INVENTION

### Technical Objects

An object of the present invention is to simplify the external appearance of the door by embedding all parts excluding the pushing part inside the door, which is equipped with a door lock, thereby enhancing the interior decor, and also to prevent vibration or impulsive noise from occurring by allowing the door lock to be quickly released when operated and to be slowly operated when released.

Another object of the present invention is to provide a door lock for an exit device that can restrict relocation of the deadbolt of the door lock, in a state where pressure is not applied to the push bar.

### Technical Solutions

According to the present invention an exit device comprises a device frame inserted into a door panel; a damper part inserted into the device frame and provided to absorb and mitigate impulsive power generated according to the operation of pushing parts; the pushing parts provided at both sides of the damper part to be pressable by pressure applied by a user; a slider provided to slidingly reciprocate along the device frame by the pushing parts at another side; and a slide bar coupled to the slider at one side and provided to have its other side thereof coupled to a deadbolt of a door locking/unlocking the door.

Additionally, the device frame has frame reinforcing members each having a “ [symbol] ” shape being coupled to both inner sides of a frame member having a “ [symbol] ” shape.

Additionally, the damper part comprises a damper plate provided with a slide long hole having a rack gear at a mid-portion; a decelerator having a pinion gear interlocking with the rack gear and provided to decelerate rotation of the pinion gear; a fixed buffer part separated from the damper plate and fixed to be device frame, the fixed buffer part being provided with a buffer member at each corner having a “ [symbol] ” shape; and a movable buffer part facing into and contacting the fixed buffer part of the buffer member and having a buffer member corresponding to both sides of the damper plate, respectively.

Additionally, a pushing part comprises a pushing support piece being fixed to the device frame; a pushing arm being rotatably coupled to the pushing support piece by a first hinge shaft; a tilted arm being rotatably coupled to a mid-portion of the pushing arm by a second hinge shaft and having an end coupled to a third hinge shaft, the third hinge shaft being provided to have one end fasten one side of a spring; a pushing piece being coupled to an end of the pushing arm by a fourth hinge shaft; and another side of the spring being fastened to the first hinge shaft.

Additionally, the slider comprises a slider body having a “ [symbol] ” shape; and a rod joining piece having a vertical rod joining hole provided at an end of the slider body, the vertical rod joining hole being perpendicularly bent along a forward direction.

Additionally, the slide bar comprises a slide bar body having a “ [symbol] ” shape being coupled to a nut; a first slide shaft being coupled to the slide bar body; a handle rotating piece having a “ [symbol] ” shape and being fastened in order to apply pressure on a first spring, the first spring being fastened to the first slide shaft; a slide guide piece being provided to face into and contact the handle rotating piece and being coupled to a third slide shaft, the third slide shaft being fastened to have a second slide shaft pass through; and a second spring being fastened to an outer periphery of the third slide shaft, wherein the second slide shaft passing through the third slide shaft is coupled to the door lock deadbolt locking/unlocking the door.

Additionally, the third slide shaft has a hollow form and is provided with a spiral groove on an outer periphery thereof.

Additionally, the second slide shaft comprises a second slide shaft body having a predetermined diameter; a slide head being provided on an end of the second slide shaft body and having repeated recessed grooves on an outer periphery thereof, wherein the slide head has a larger diameter than a diameter of the second slide shaft body, and wherein the slide head is provided with a pin hole passing through the slide head along a direction perpendicular to the shaft direction.

Additionally, the exit device comprises a protrusion being provided on the slide bar at an end portion of the slide bar body along a direction of the deadbolt; and a brake piece being rotatably fixed by a rotating part provided on one side of the door lock, wherein the brake piece contacts the protrusion in a region adjacent to the rotating part, and wherein the brake piece makes vertical rotating movements along the rotating part according to back-and-forth movements of the slide bar.

Additionally, a thickness of the brake piece increases along a direction of the rotating part.

Additionally, an inside of the slide bar body has a hollow form allowing the first slide shaft to freely move along an inner periphery of the slide bar body within the hollow, wherein a diameter of the end portion of the first slide shaft is configured to be larger than a diameter of a mid-portion of the first slide shaft so as to prevent the first slide shaft from falling out of the slide bar body, and wherein the first slide shaft is provided with a first spring being elastically formed between an inner region of the slide bar body and the end portion of the first slide shaft, the first spring being extended or reduced according to the movement of the first slide shaft.

Furthermore, according to the present invention a door lock of an exit device, wherein the exit device comprises a slider being installed on a door panel to be pressable by pressure applied by a user and being provided to slidingly reciprocate along the device frame by pushing parts; a slide bar coupled to the slider at one side; and another side of the slide bar being coupled to a deadbolt of a door locking/unlocking the door, the door lock comprises a brake piece installed on one side of the door lock, so as to restrict or allow movements of the deadbolt.

The brake piece is rotatably fixed by a rotating part, the rotating part being formed to be adjacent to the slide bar, wherein the brake piece contacts a protrusion in a region adjacent to the rotating part, the protrusion being provided on the slide bar at an end portion of the slide bar body along a direction of the deadbolt, and wherein the brake piece makes vertical rotating movements along the rotating part according to back-and-forth movements of the slide bar, and wherein, when the slide bar does not move back and forth, and end or part of the brake piece supports the deadbolt, so as to restrict the movement of the deadbolt.

A thickness of the brake piece increases along a direction of the rotating part.

### Effects of the Invention

By embedding all parts excluding the pushing part inside the door, the present invention may have the effect of having a simple appearance.

Additionally, with this, the present invention may have the effect of enhancing spatial efficiency.

Additionally, with this, the present invention may have the effect of enhancing interior decor.

Additionally, by allowing the pressure and operation of the pushing part to be controlled by the damper, the present invention may have the effect of quickly releasing the door lock when operated and slowly operating the door lock when released.

Additionally, with this, the present invention may have the effect of preventing vibration or impulsive noise from occurring.

Additionally, the present invention may have the effect of extending its duration.

Additionally, by configuring a brake piece restricting the entry of the deadbolt to allow the brake piece to make up-and-down rotating movements according to the back-and-forth movements of the slide bar, the brake piece may make up-and-down rotation movements so as to allow the deadbolt to smoothly move when operating the push bar, and the brake piece may also restrict the movement of the deadbolt when someone intends to open the door by artificially applying pressure only on the deadbolt without operating the push bar. Thus, the present invention may have the effect of preventing the door from opening without operating the push bar.

Furthermore, by forming an inside of the slide bar body to have a hollow form, when applying pressure on the deadbolt to allow the deadbolt to change back-and-forth directions of the door, a first slide body may freely flow inside the slide bar body. Accordingly, the deadbolt may retreat or move forward without having pressure applied on the push bar. Thus, the deadbolt may be configured to easily change the back-and-forth direction of the door.

### BRIEF DESCRIPTION OF THE DRAWINGS

FIG. 1 is a diagram showing a perspective view of a door applying an exit device according to the present invention.

FIG. 2 is a diagram showing a perspective view of an exit device according to the present invention.

FIG. 3 is a diagram showing a perspective view of an inside of the exit device according to the present invention.

FIG. 4 is a diagram showing a perspective view of a backside of the exit device according to the present invention.

FIG. 5 is a diagram showing an enlarged perspective view of a main part of the exit device according to the present invention.

FIG. 6 is a diagram showing an enlarged perspective view of a main part of the exit device according to the present invention.

FIG. 7 is a diagram showing an enlarged bottom perspective view of a main part of the exit device according to the present invention.

FIG. 8 is a diagram showing an enlarged exploded perspective view of a main part of the exit device according to the present invention.

FIG. 9 is a diagram showing a plane view of a brake piece movement of the exit device according to an embodiment of the present invention.

FIG. 10 is a diagram showing a plane view of a brake piece movement of the exit device according to another embodiment of the present invention.

### MODE FOR CARRYING OUT THE INVENTION

Hereinafter, an exemplary embodiment of the present invention will be described in detail with reference to the accompanying drawings so that anyone skilled in the art can easily carry out the present invention. However, it shall be understood that the present invention may be embodied in different variations and that the present invention will not be limited only to the exemplary embodiment presented herein. Furthermore, it shall also be understood that parts of the invention that are irrelevant to the detailed description of the present invention have been omitted for clarity of the description of the present invention. It will be apparent that throughout this specification similar numeral references have been given to similar parts of the invention.

Throughout the entire specification of the present invention, when a particular part is said to “include” a particular element, this indicates that, unless specified otherwise, the corresponding part may further include another element (or other elements), and, therefore, this does not indicate that the corresponding part excludes the other element(s).

Additionally, terms indicated as “ . . . unit”, “ . . . part”, “ . . . device”, “ . . . module”, and so on, indicates a unit executing or processing at least one function or operation.

The exit device according to the present invention is devised to have a simple appearance by embedding all parts excluding the pushing part inside the door, and to allow the door lock to be quickly released when operated and to be slowly operated when released, thereby preventing vibration or impulsive noise from occurring.

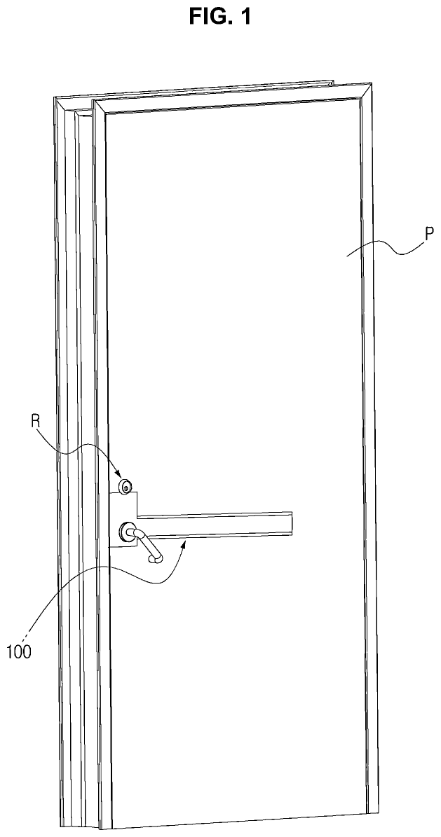

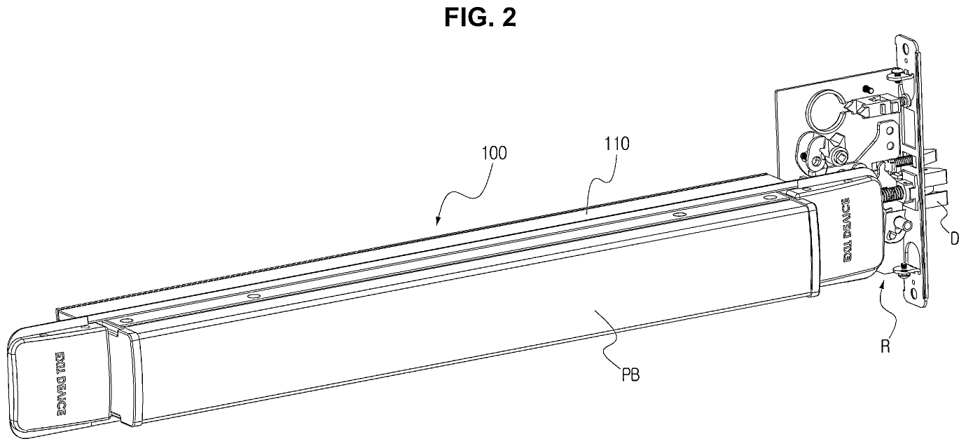

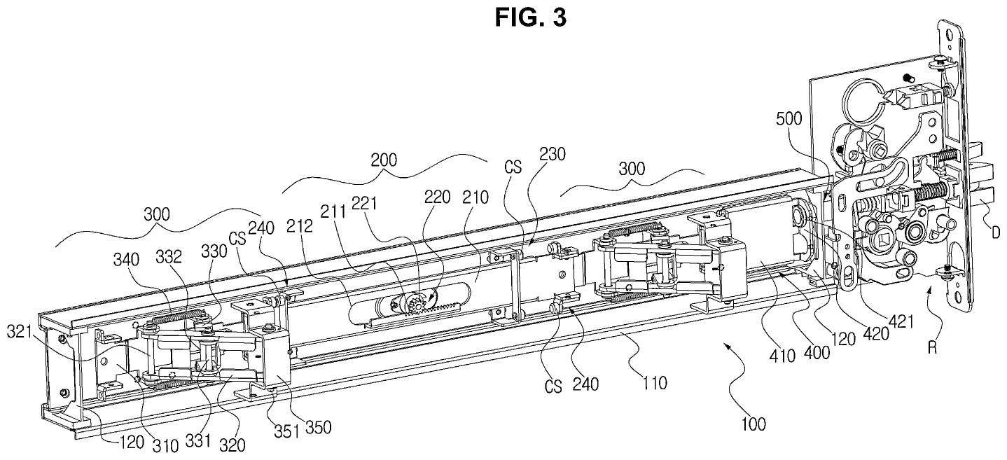

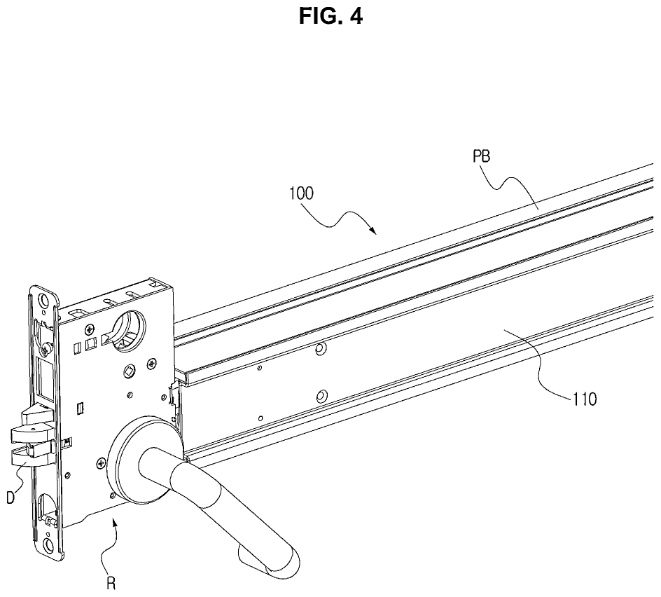

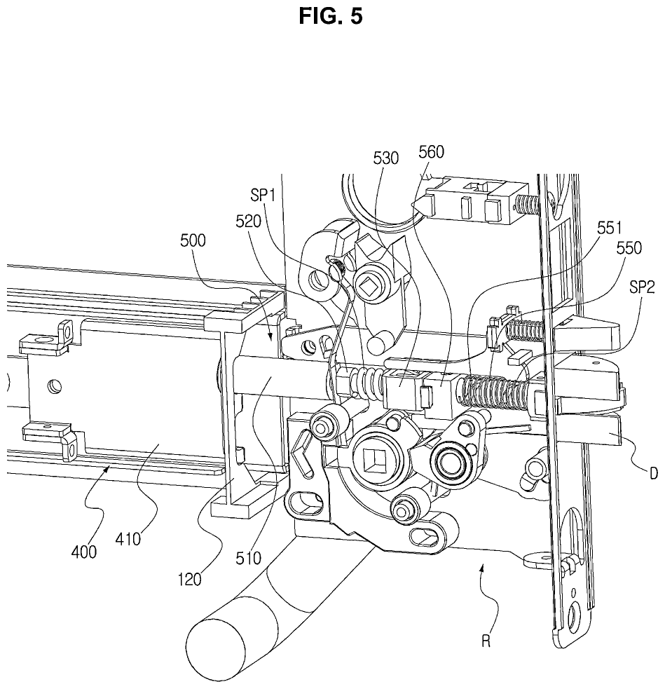

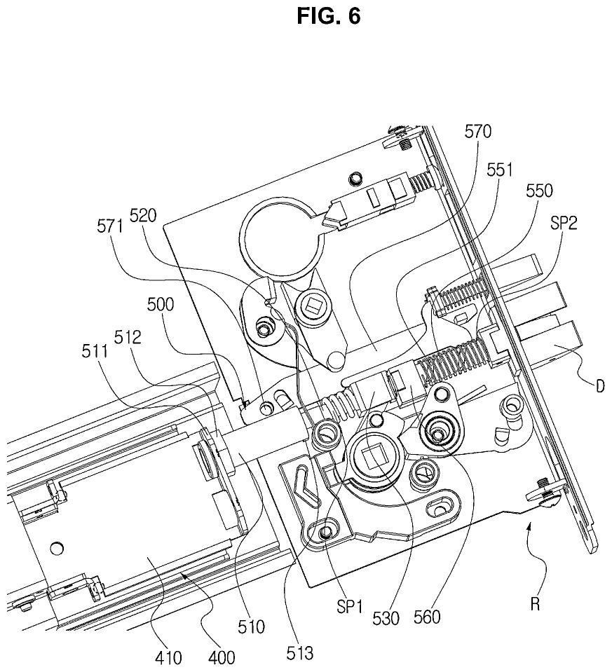

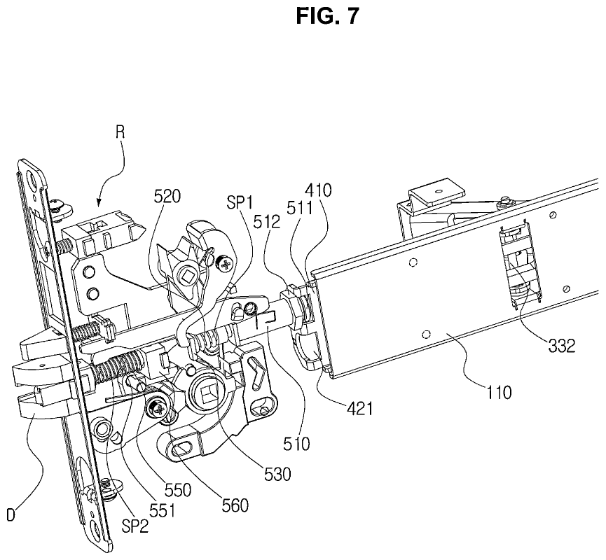

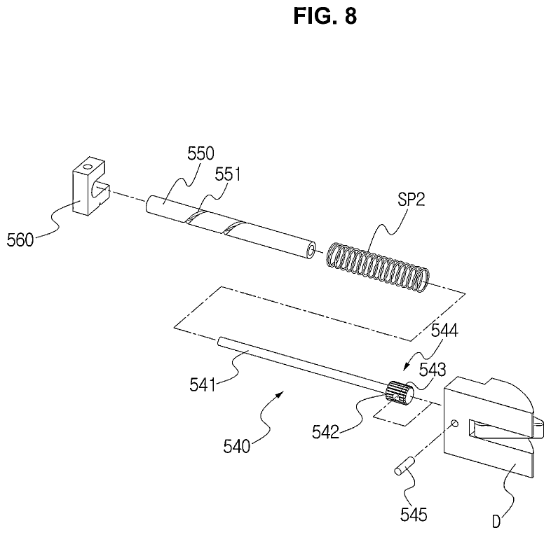

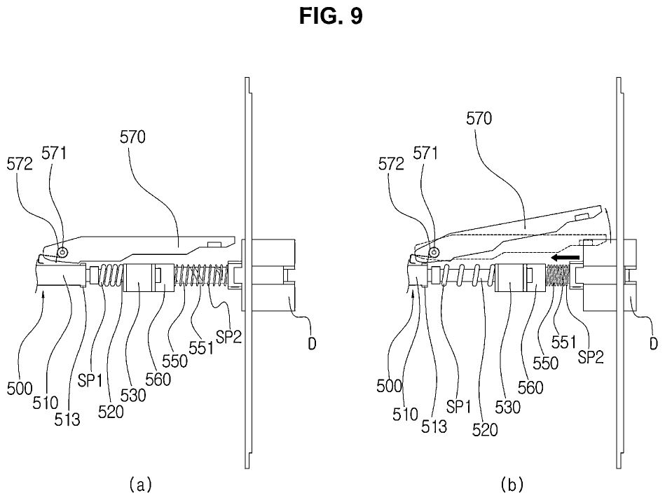

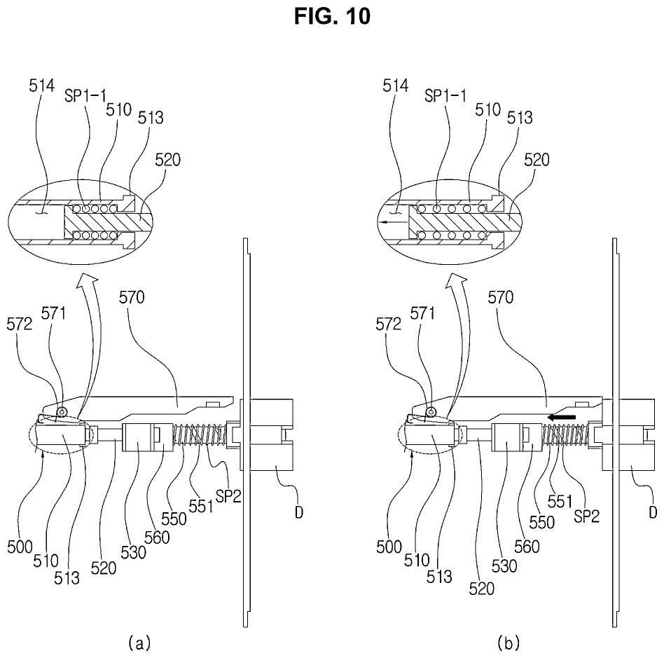

FIG. 1 is a diagram showing a perspective view of a door applying an exit device according to the present invention. FIG. 2 is a diagram showing a perspective view of an exit device according to the present invention. FIG. 3 is a diagram showing a perspective view of an inside of the exit device according to the present invention. FIG. 4 is a diagram showing a perspective view of a backside of the exit device according to the present invention. FIG. 5 is a diagram showing an enlarged perspective view of a main part of the exit device according to the present invention. FIG. 6 is a diagram showing an enlarged perspective view of a main part of the exit device according to the present invention. FIG. 7 is a diagram showing an enlarged bottom perspective view of a main part of the exit device according to the present invention. FIG. 8 is a diagram showing an enlarged exploded perspective view of a main part of the exit device according to the present invention. FIG. 9 is a diagram showing a plane view of a brake piece movement of the exit device according to an embodiment of the present invention. And, FIG. 10 is a diagram showing a plane view of a brake piece movement of the exit device according to another embodiment of the present invention.

As shown in FIG. 1 to FIG. 10, the exit device according to the present invention is configured to include a device frame 100, a damper part 200, pushing parts 300, a slider 400, and a slide bar 500.

Herein, the device frame 100 is inserted into a door panel P and provided to stably support the damper part 200, the pushing parts 300, the slider 400, and a slide bar 500, wherein the device frame 100 is configured as a frame member 110 having a “ [symbol] ” shape that is coupled to frame reinforcing members 120 each having a “ [symbol] ” shape and being inserted into each end portion on both sides of the frame member 110, so as to prevent the device frame 100 from being deformed.

The damper part 200 is provided to be inserted inside the device frame 100, so as to absorb and mitigate impulsive force, which occurs in accordance with the operation of the pushing parts 200.

The damper part 200 includes a damper plate 210, a decelerator 220, a fixed buffer part 230, and a movable buffer part 240, wherein the damper plate 210 is provided with a sliding long hole 212 having a rack gear 211 at a mid-portion, and wherein the decelerator 220 has a pinion gear 221 interlocking with the rack gear 211 and is provided to decelerate the rotation of the pinion gear 221. At this point, it is preferable that a spring type or a hydraulic type deceleration may be used for the deceleration of the pinion gear 221. Accordingly, by having the damper part 200 control the pressure or operation of the pushing parts, the door lock may be quickly released when operated and may be slowly operated when released.

In order to prevent interference from occurring while the damper plate 210 slidingly reciprocates, the fixed buffer part 230 is provided with a buffer member CS at each corner having a “ [symbol] ”, shape so as to be separated from the damper plate 210 and fixed to the device frame 100.

The movable buffer part 240, which faces into and contacts the fixed buffer part 230 of the buffer member CS, is provided to have a buffer member CS corresponding to both sides of the damper plate 210, respectively. Thus, noise caused by the impulse during the operation process may be prevented.

The pushing parts 300 are provided on both sides of one damper part 200, which may be interlinked at the same time as the user presses on the push bar PB, which is provided at an end portion of the pushing part 300. Herein, each pushing part 300 is provided with a pushing support piece 310 being fixed to the device frame 100, and the pushing support piece 310 is provided with a pushing arm 320 that can be rotated toward a first hinge shaft 321.

Additionally, a tilted arm 330 is provided to be rotatably connected to a mid-portion of the pushing arm 320 by a second hinge shaft 331 and also having its end connected to a third hinge shaft 332, which is provided to be fastened to one side of a spring 340. A pushing piece 350 is connected to an end portion of the pushing arm 320 by a fourth hinge shaft 351, and another side of the spring 340 may be fastened to the first hinge shaft 321.

The slider 400 is provided to slidingly reciprocate along the device frame 100 by another side of the pushing part 300, and the slider 400 may be linked to the slide bar 500.

For this, a slider body 410 having a “ [symbol] ” shape is provided, and a rod joining piece 420 having a vertical rod joining hole 421 is provided at an end portion of the slider body 410, wherein the vertical rod joining hole 421 is perpendicularly bent along a forward direction. At this point, the vertical rod joining hole 421 is provided to be easily used even when a door locking part is vertically changed during the installation process.

The slide bar 500 allows the deadbolt D of the door lock R to be unlocked by pushing or pulling the deadbolt D. Herein, while the slide bar 500 has one side connected to the slider 400, the slide bar 500 is provided to have another side coupled to (or joined with) the deadbolt D of the door lock R, which locks and unlocks the door.

The above-described slide bar 500 has a fastening groove 511, a first slide shaft 520 is coupled to a slide bar body 510, which is provided to be coupled to a nut 512, and a handle rotating piece 530 having a “ [symbol] ” shape is provided to be fastened in order to apply pressure on a first spring SP1, which is fastened to the first slide shaft 520.

Additionally, a slide guide piece 560 that is provided to be coupled to a third slide shaft 550, which is fastened to have a second slide shaft 540 pass through, is provided to face into and contact the handle rotating piece 530. A second spring SP2 is fastened to an outer periphery of the third slide shaft 550, while the second slide shaft 540 passing through the third slide shaft 550 is coupled to the deadbolt D of the door lock R allowing the door to be locked and unlocked.

The second slide shaft 540 is provided with a slide head 544, which is provided on an end portion of a second slide shaft body 541 having a predetermined diameter. Herein, the slide head 544 is provided with repeated recessed grooves 542 on an outer periphery of the slide head 544, wherein the slide head 544 has a larger diameter than the diameter of the second slide shaft body 541. The slide head 544 is also provided with a pin hole 543 that passes through the slide head 544 along a direction perpendicular to the shaft direction.

The above-described slide head 544 is inserted in the deadbolt D so as to be coupled (or joined) by a fixing pin 545, which prevents the slide head 544 from being detached from the deadbolt D while allowing the deadbolt D to operate smoothly.

The third slide shaft 550 has a hollow form, and a spiral groove 551 is provided on an outer periphery of the third slide shaft 550, thereby reducing the occurrence of frictional resistance during its operation and allowing a separate lubricant to be injected therein.

Meanwhile, as shown in FIG. 6 and FIG. 9, a protrusion 513 is provided on an end portion of the slide bar 500 along the direction of the deadbolt D, wherein at least one protrusion 513 is provided. A brake piece 570 contacting a surface (rear surface) of the push bar PB of the deadbolt D, when the deadbolt D retreats, is provided to restrict the flow of the deadbolt D, thereby preventing the door from opening.

That is, the door lock of the exit device comprises a slider 400 being installed to a door panel and pushed by pressure applied by a user and being provided to slidingly reciprocate along a device frame by pushing parts 300; a slide bar 500 having one side coupled to the slider 400; and a brake piece 570 including a door lock R having a deadbolt D coupled to another side of the slide bar 500, so as to allow a door to be locked and unlocked, and being installed to one side of the door lock R so as to restrict or allow movements of the deadbolt D.

The brake piece 570 is rotatably fixed to rotate along a rotating part 571, which is formed on one side of the door lock R. Usually, when the deadbolt D is flowing, an end portion of the brake piece 570 is positioned horizontally so as to face into and contact the deadbolt D. And, when applying pressure to the push bar PB, the brake piece 570 rotates counterclockwise along the rotating part 571, thereby allowing the deadbolt D to flow freely.

When the slide bar 500 makes forward-and-backward movements according to the pressure applied to the push bar PB, as the protrusion 513 moves along the direction of the rotating part 571 (the direction of the push bar) of the brake piece 570, the brake piece 570 may operate to rotate counterclockwise. That is, since the brake piece 570 does not rotate without the operation of the push bar PB or the movement of the protrusion 513, it is impossible to move the deadbolt D or apply pressure to the deadbolt D by other operations excluding the operation of the push bar PB.

In order to allow the brake piece 570 to rotate, a surface contacting the protrusion 513 of the brake piece 570 has a stepped structure. That is, a thickness of the brake piece 570 becomes thicker from the direction of the deadbolt D to the direction of the push bar PB, and it is preferable that the thickness becomes gradually thicker. And, the protrusion 513 rotatably operates by moving back and forth from a displacement point where the thickness changes.

In this case, instead of operating the push bar PB, if the user intends to open the door by artificially applying pressure only to the deadbolt D, the brake piece 570 does not rotate counterclockwise, thereby restricting the movement of the deadbolt D. Therefore, without operating the push bar PB, the door cannot be open.

FIG. 10 illustrates a same movement of the brake piece 570, as shown in FIG. 9. The difference between the two drawings is that, in FIG. 9, a first spring SP1 is located outside of a slide bar body 510, and, in FIG. 10, a first spring SP1-1 is located inside of a slide bar body 510. In this case, the drawing describes a case where pressure is applied to the deadbolt D without operating the push bar B. A first slide shaft 520 that is inserted inside the slide bar body 510 has a lower end diameter that is larger than the diameter of the first slide shaft 520 inserting part of the slide bar body 510, thereby preventing the first slide shaft 520 from falling outside of the slide bar body 510. Thus, the first slide shaft 520 may flow within the slide bar body 510 from left-to-right. At this point, the lower end of the first slide shaft 520 performs the role of a stopper, thereby allowing the first spring SP1-1 to apply it elasticity without deviating from the first slide shaft 520. When pressure is applied to the deadbolt D toward the inside, a second elastic spring SP2 is compressed, and the first slide shaft 520 moves along a direction of the first spring SP1-1 being inserted inside the slide bar body 510. The first slide shaft 520 is movable because a void space 514 is formed inside the slide bar body 510. Due to this the void space 514 the first spring SP1-1 may move freely inside the slide bar body 510. When the force applied to the deadbolt D is released, the first spring SP1-1 returns to its initial state, and the first slide shaft 520 moves toward the initial position of the deadbolt D.

When forming the inside of the slide bar body 510 to have a hollow form, and applying pressure to the deadbolt D for a back-to-forth direction change of a door of the deadbolt D, the first slide shaft 520 may move freely inside the slide bar body. Accordingly, the deadbolt D may retreat or move forward without any pressure applied to the push bar. Thus, the deadbolt D may be configured to easily perform back-to-forth direction change of the door od the deadbolt D. As shown in the drawing, the deadbolt D may be configured to have one curved surface and one flat surface. Herein, when closing the door, pressure is applied to the curved surface of the deadbolt D, thereby allowing the deadbolt D to move forward and backward (or retreat). And, when required, the curved surface may be directed toward a front surface of the door or may be directed toward a rear surface of the door, and this direction should be changed freely. For this, the deadbolt D should be configured to be capable of moving back-and-forth freely inside the door lock. In order to achieve this, the present invention has implemented the inside of the slide bar body 510 to have a hollow form and has implemented the first slide shaft 520 to be capable of freely moving back-and-forth through the hollow form of the slide bar body 510.

It shall be noted that the embodiments set forth herein are provided to describe the embodiments according to the present invention, and not to limit the present invention. Furthermore, it may be understood by anyone with ordinary skills in the field that other various embodiments may also be implemented without deviating from the technical scope and spirit of the present invention.

1. An exit device, comprising:
a device frame inserted into a door panel;
a damper part inserted into the device frame and provided to absorb and mitigate impulsive power generated according to the operation of pushing parts;
the pushing parts provided at both sides of the damper part to be pressable by pressure applied by a user;
a slider provided to slidingly reciprocate along the device frame by the pushing parts at another side; and
a slide bar coupled to the slider at one side and provided to have its other side thereof coupled to a deadbolt of a door locking/unlocking the door.

2. The exit device of claim 1, wherein the device frame has frame reinforcing members each having a “ [symbol] ” shape being coupled to both inner sides of a frame member having a “ [symbol] ” shape.

3. The exit device of claim 1, wherein the damper part comprises:
a damper plate provided with a slide long hole having a rack gear at a mid-portion;
a decelerator having a pinion gear interlocking with the rack gear and provided to decelerate rotation of the pinion gear;
a fixed buffer part separated from the damper plate and fixed to be device frame, the fixed buffer part being provided with a buffer member at each corner having a “ [symbol] ” shape; and
a movable buffer part facing into and contacting the fixed buffer part of the buffer member and having a buffer member corresponding to both sides of the damper plate, respectively.

4. The exit device of claim 1, wherein a pushing part comprises:
a pushing support piece being fixed to the device frame;
a pushing arm being rotatably coupled to the pushing support piece by a first hinge shaft;
a tilted arm being rotatably coupled to a mid-portion of the pushing arm by a second hinge shaft and having an end coupled to a third hinge shaft, the third hinge shaft being provided to have one end fasten one side of a spring;
a pushing piece being coupled to an end of the pushing arm by a fourth hinge shaft; and
another side of the spring being fastened to the first hinge shaft.

5. The exit device of claim 1, wherein the slider comprises:
a slider body having a “ [symbol] ” shape; and
a rod joining piece having a vertical rod joining hole provided at an end of the slider body, the vertical rod joining hole being perpendicularly bent along a forward direction.

6. The exit device of claim 1, wherein the slide bar comprises:
a slide bar body having a “ [symbol] ” shape being coupled to a nut;
a first slide shaft being coupled to the slide bar body;
a handle rotating piece having a “ [symbol] ” shape and being fastened in order to apply pressure on a first spring, the first spring being fastened to the first slide shaft;
a slide guide piece being provided to face into and contact the handle rotating piece and being coupled to a third slide shaft, the third slide shaft being fastened to have a second slide shaft pass through; and
a second spring being fastened to an outer periphery of the third slide shaft,
wherein the second slide shaft passing through the third slide shaft is coupled to the door lock deadbolt locking/unlocking the door.

7. The exit device of claim 6, wherein the third slide shaft has a hollow form and is provided with a spiral groove on an outer periphery thereof.

8. The exit device of claim 6, wherein the second slide shaft comprises:
a second slide shaft body having a predetermined diameter;
a slide head being provided on an end of the second slide shaft body and having repeated recessed grooves on an outer periphery thereof, wherein the slide head has a larger diameter than a diameter of the second slide shaft body, and wherein the slide head is provided with a pin hole passing through the slide head along a direction perpendicular to the shaft direction.

9. The exit device of claim 6, comprising:
a protrusion being provided on the slide bar at an end portion of the slide bar body along a direction of the deadbolt; and
a brake piece being rotatably fixed by a rotating part provided on one side of the door lock, wherein the brake piece contacts the protrusion in a region adjacent to the rotating part, and wherein the brake piece makes vertical rotating movements along the rotating part according to back-and-forth movements of the slide bar.

10. The exit device of claim 9, wherein a thickness of the brake piece increases along a direction of the rotating part.

11. The exit device of claim 6, wherein an inside of the slide bar body has a hollow form allowing the first slide shaft to freely move along an inner periphery of the slide bar body within the hollow, wherein a diameter of the end portion of the first slide shaft is configured to be larger than a diameter of a mid-portion of the first slide shaft so as to prevent the first slide shaft from falling out of the slide bar body, and wherein the first slide shaft is provided with a first spring being elastically formed between an inner region of the slide bar body and the end portion of the first slide shaft, the first spring being extended or reduced according to the movement of the first slide shaft.

12. A door lock of an exit device, wherein the exit device comprises a slider being installed on a door panel to be pressable by pressure applied by a user and being provided to slidingly reciprocate along the device frame by pushing parts; a slide bar coupled to the slider at one side; and another side of the slide bar being coupled to a deadbolt of a door locking/unlocking the door, the door lock comprising:
a brake piece installed on one side of the door lock, so as to restrict or allow movements of the deadbolt.

13. The door lock of an exit device of claim 12, wherein the brake piece is rotatably fixed by a rotating part, the rotating part being formed to be adjacent to the slide bar,
wherein the brake piece contacts a protrusion in a region adjacent to the rotating part, the protrusion being provided on the slide bar at an end portion of the slide bar body along a direction of the deadbolt, and wherein the brake piece makes vertical rotating movements along the rotating part according to back-and-forth movements of the slide bar, and
wherein, when the slide bar does not move back and forth, and end or part of the brake piece supports the deadbolt, so as to restrict the movement of the deadbolt.

14. The door lock of an exit device of claim 12, wherein a thickness of the brake piece increases along a direction of the rotating part.

15. The door lock of an exit device of claim 13, wherein a thickness of the brake piece increases along a direction of the rotating part.
